(19) United States
(12) Patent Application Publication
(10) Pub. No.: US 2025/0332769 A1
(43) Pub. Date: Oct. 30, 2025

(54) METHOD TO PRODUCE A SUBSTRATE

(71) Applicant: Välinge Innovation AB, Viken (SE)

(72) Inventors: Pontus GAMSTEDT, KATTARP (SE); Anders LINDÉN, Askim (SE)

(73) Assignee: Välinge Innovation AB, Viken (SE)

(21) Appl. No.: 19/186,878

(22) Filed: Apr. 23, 2025

(30) Foreign Application Priority Data
Apr. 24, 2024 (SE) 2450450-8

(51) Int. Cl. B29C 44/34; B29C 44/30; B29K 101/12; B29K 105/00; B29K 105/04

(52) U.S. Cl. CPC B29C 44/3415; B29C 44/30; B29K 2101/12; B29K 2105/04; B29K 2105/251

(57) ABSTRACT

The present disclosure relates to a method to produce a substrate comprising at least one foamed layer. The method comprises applying a compounded material on a carrier, wherein the compounded material comprises a thermoplastic material and a blowing agent, applying heat and pressure in a pressing device to the compounded material to form the at least one foamed layer, wherein the blowing agent has an activation temperature being higher than processing temperatures for forming the compounded material.

### FIELD OF THE INVENTION

The present disclosure relates to a method to produce a substrate comprising at least one foamed layer. The substrate may form, or form part of, a building panel, such as a floor panel.

### TECHNICAL BACKGROUND

Various types of floorings having a thermoplastic core have gained popularity. Examples of such floorings include flooring material referred to as Luxury Vinyl Tile (LVT tile), Stone Plastic (Polymer) Composite panel or Solid Polymer Core panel (SPC panel), or Expanded Polymer Core panel (EPC panel), also known as Water Proof Core panel or Wood Plastic Composite panel (WPC panel). The floor panels conventionally comprise a core, a print layer, a wear layer arranged on the print layer, and a coating layer arranged on the wear layer. Optionally, a backing layer may be arranged on a lower side of the core, intended to face a sub-floor. The core conventionally comprises a thermoplastic material and fillers.

In order reduce weight of such floor panels, lightweight fillers may be included in the core, or the core may be foamed, for example by physical and/or chemical blowing agents. The core may be produced by various methods, such as extrusion, pressing, calendering, etc.

WO 2013/179261 A1 discloses a method to form a panel by applying granulates of a thermoplastic material to form a first layer of a substrate, applying a glass fibre layer on the first layer, and applying granulates of the thermoplastic material on the glass fibre layer to form a second layer of the substrate, and the layers are consolidated to form the panel.

As mentioned in US 2020/0016799 A1, it seems difficult to obtain an acceptable foaming in the substrate when using granulates to form the substrate as described in WO 2013/179261 A1, as the blowing agent in the granulate in fact seems to have partially lost its function in the granulating process. Document BE 2015/5572, also published as U.S. Pat. No. 10,961,721 B2, responds to this disadvantage by strewing a dry-blend material to form a substrate instead of granulates as in WO 2013/179261 A1. The dry-blend material is thermoplastic. The blowing agent that is blended into the dry-blend, contrary to granulate, may keep its function in good order, by which a better foaming may be obtained.

US 2020/0016799 A1 addresses the problem that it seems to be difficult to obtain a high filling degree in the substrate without this substrate becoming too brittle by using the method of BE 2015/5572. US 2020/0016799 A1 suggest strewing the thermoplastic material in form of a micronized material. By a micronized material is understood to define material that has undergone micronization. The average particle size of the micronized material, expressed as the D-50 value or the median of the distribution, is preferably smaller than 1 mm. The thermoplastic material to be strewn can be a mixture of a blowing agent and the micronized material.

However, there is still a need to improve distribution of a blowing agent, for example, compared to strewing a mixture of a thermoplastic material and a blowing agent.

### SUMMARY

An object of at least examples of the present disclosure is to provide an improved method to produce a substrate.

An object of at least examples of the present disclosure is to provide a method resulting in an improved foamed substrate.

An object of at least examples of the present disclosure is to provide improved distribution of a blowing agent in a method to produce a substrate.

According to a first aspect of the present disclosure, a method to produce a substrate comprising at least one foamed layer is provided. The method comprises:
applying a compounded material on a carrier, wherein the compounded material comprises a thermoplastic material and a blowing agent,
applying heat and pressure in a pressing device to the compounded material to form the at least one foamed layer,
wherein the blowing agent has an activation temperature being higher than processing temperatures for forming the compounded material.

The compounded material may be formed by an extrusion process, or similar kneading process. The processing temperatures may be the temperatures of the extrusion process, or similar kneading process.

An extrusion process, or similar kneading process, may be commonly referred to as a compounding process. The processing temperatures may be the temperatures of the compounding process, such as the extrusion temperature.

The compounded material may be formed in the compounding process.

The blowing agent may have an activation temperature being higher than processing temperatures for forming the compounded material in the compounding process.

The compounding process may be performed prior to the method of the first aspect.

In the compounding process, the thermoplastic material and the blowing agent may be mixed to the compounded material.

In one example, the method may comprise:
applying compounded pellets, or particles obtained from compounded pellets, on a carrier, wherein the compounded pellets comprise a thermoplastic material and a blowing agent,
applying heat and pressure in a pressing device to the compounded pellets, or the particles obtained from the compounded pellets, to form the at least one foamed layer,
wherein the blowing agent has an activation temperature being higher than processing temperatures for forming the compounded pellets.

In examples, by compounding the compounded material at processing temperatures below the activation temperature of the blowing agent, the foaming capacity of the blowing agent is not activated, or is substantially not activated, such as less than 10% of the blowing agent is activated, during the compounding process. By compounding the material including the blowing agent therein, the blowing agent is uniformly distributed, or at least substantially uniformly distributed, through the compounded material, such that a uniform foaming can be obtained in a subsequent activation step, such as the pressing step. The blowing agent may be well dispersed in the compounded material during the compounding process.

The activation temperature of the blowing agent may be the temperature at which the blowing agent begins to react.

The activation temperature may be the temperature specified by the producer of the blowing agent as the activation temperature. For example, if the activation temperature for a certain blowing agent is specified as 190° C., the activation temperature of the blowing agent is 190° C.

In aspects, the blowing agent may have a decomposition temperature being higher than processing temperatures for forming the compounded material, such as the processing temperatures of the compounding process.

Thereby, the foaming capacity of the blowing agent is substantially not activated, such as less than 20% of the blowing agent is activated.

The decomposition temperature of the blowing agent may be the temperature at which the blowing agent undergoes significant thermal decomposition, such as at least 25% of the blowing agent has decomposed.

The decomposition temperature may be the temperature specified by the producer of the blowing agent as the decomposition temperature.

The compounded material may be compounded pellets or particles obtained from compounded pellets.

An example of particles obtained from compounded pellets are considered compounded particles being reduced in particles size, such as grinded to a reduced particles size.

The compounded material, such as the compounded pellets, may be formed by a compounding process, such as an extrusion process or similar kneading process.

The compounded pellets may be formed by an extrusion process or similar kneading process.

The compounded material, such as the compounded pellets, may have been processed in an at least partly molten or gelled state in the compounding process.

The compounded material, such as the compounded pellets, may have been subjected to a shear treatment in a compounding process, such as having been subjected to shear forces, to obtain the compounded pellets. The shear forces may be applied in an extrusion process, or similar kneading process.

The compounding process may be performed prior to applying the compounded material, such as the compounded pellets, on the carrier.

The method may further comprise compounding the thermoplastic material and the blowing agent to the compounded material.

Substantially each compounded pellet, such as at least 90% of the compounded pellets, may comprise the thermoplastic material and the blowing agent.

A pressing temperature when applying heat and pressure may be higher than the activation temperature of the blowing agent such that the at least one foamed layer is foamed during and/or after pressing.

A pressing temperature when applying heat and pressure may be higher than the decomposition temperature of the blowing agent such that the at least one foamed layer is foamed during and/or after pressing.

The foaming process may be initiated during pressing and may continue when pressure is released.

The pressing temperature may be higher than the processing temperatures for forming the compounded material.

The pressing temperature may exceed 200° C. In other examples, the pressing temperature may exceed 230° C.

The activation temperature of the blowing agent may be or exceed 200° C. In other examples, the activation temperature may be or exceed 230° C.

The compounded material, such as the compounded pellets, may be formed at processing temperatures being less than 200° C. In other examples, the compounded material, such as the compounded pellets, may be formed at processing temperatures being less than 230° C.

The compounded material, such as the compounded pellets, may be formed at processing temperatures exceeding 120° C., such as 130-230° C. In other examples, the compounded material, such as the compounded pellets, may be formed at processing temperatures between 130-200° C.

The compounded material may be formed in a compounding process, in which the compounded material is formed at the processing temperatures.

Irrespective of the actual temperature, the processing temperatures for forming the compounded material may be less than the activation temperature of the blowing agent. Further, a pressing temperature when applying heat and pressure may be higher than the activation temperature of the blowing agent such that the at least one foamed layer is foamed during and/or after pressing.

The method may further comprise forming the compounded material, wherein the processing temperatures may be less than 200° C., wherein the compounded material is formed at the processing temperatures.

The compounded material may be formed in a compounding process, wherein the processing temperatures of the compounding process may be less than 200° C.

The processing temperatures indicated above may be the temperature of the extrusion equipment, or similar kneading equipment.

The pressing temperatures may be the temperature of the pressing device, such as the temperature of the heating elements and/or press plates.

The blowing agent may be chosen from the group of azo compounds, hydrazine derivates, semicarbazides, tetrazoles, nitroso compounds, carbonates, and expandable microspheres.

The blowing agent may be exothermic.

The blowing agent may be or comprise azodicarbonamide (ADCA).

The thermoplastic material may be a polyolefin.

The thermoplastic material may be chosen from the group of PVC, PP, PE, PET, TPU, PVAc, PVB, and a combination thereof.

The compounded pellets may have a diameter and/or a thickness of 0.5 to 5 mm.

The compounded pellets may have a length of 1 to 3 mm.

A first layer of the compounded material may be applied on the carrier and a second layer of the compounded material may be applied on the first layer.

The composition of the compounded material of the first layer may be different from the composition of the compounded material of the second layer.

The composition of the compounded material of the first layer may be substantially similar the composition of the compounded material of the second layer, such as the same compounded material is applied as the first layer and the second layer.

After applying heat and pressure, the first layer may form a first foamed layer, and the second layer may form a second foamed layer.

A first layer of compounded pellets, or the particles obtained from the compounded pellets, may be applied on the carrier and a second layer of the compounded pellets, or the particles obtained from the compounded pellets, may be applied on the first layer.

The method may further comprise including at least one reinforcement layer in or on the substrate.

The reinforcement layer may be or comprise fibre reinforced plastic. The reinforcement layer may comprise organic and/or inorganic fibres.

The reinforcement layer may be or comprise a glass fibre layer.

The method may further comprise applying the reinforcement layer on a first layer of the compounded material applied on the carrier, and applying a second layer of the compounded material on the reinforcement layer.

The method may further comprise applying the reinforcement layer on a first layer of the compounded pellets, or the particles obtained from the compounded pellets, applied on the carrier, and applying a second layer of the compounded pellets, or the particles obtained from the compounded pellets, on the reinforcement layer.

The pressing device may be a double belt press.

The pressing device may comprise at least one heating zone and at least one pressing zone.

The pressing device may further comprise at least one cooling zone.

Heat applied during pressing may be in the range of 200-260° C., such as 225-250° C.

Pressure applied during pressing may be in the range of 0.5-20 bar, such as 3-10 bar.

Line speed in the double belt press may be 1-15 m/min, such as 5-10 m/min.

Residence time at elevated temperature may be 1-3 min, such as 1.5-2 min.

The compounded material may be formed by mixing the thermoplastic material with the blowing agent to a dry-blend, compounding the dry-blend to obtain a thermoplastic compounded material comprising the blowing agent.

The dry-blend may be compounded in an extruder.

The compounded material may be formed by mixing and compounding the thermoplastic material with the blowing agent in an extruder.

The compounded material may be pelletized into compounded pellets.

The compounded pellets may be further reduced in size.

Prior to applying the compounded pellets on the carrier, the compounded pellets may be reduced in particle size, for example by crushing or grinding, such that particles obtained from compounded pellets.

The compounded pellets may further comprise at least one filler.

The filler, or fillers, may be CaCO₃ such as marble, limestone or chalk, talc, fly ash, or a stone material, such as stone powder.

The at least one foamed layer may have a density of 1.0-1.9 kg/dm³, such as 1.2-1.8 kg/dm³, for example 1.4-1.8 kg/dm³, as measured according to ISO 1183.

The substrate may have a density of 1.2-2 kg/dm³ as measured according to ISO 1183.

The at least one foamed layer may have a bending modulus of 2000-7000 N/mm², such as preferably 3000-6000 N/mm², as measured according to ISO 178.

The substrate may have a bending modulus of 2000-11000 N/mm² as measured according to ISO 178.

The at least one foamed layer may have a bending strength of at least 10 N/mm², such as 10-50 N/mm², for example 18-35 N/mm² as measured according to ISO 178.

The substrate may have a bending strength of at least 10 N/mm², such as 10-60 N/mm², for example 18-50 N/mm², as measured according to ISO 178.

The at least one foamed layer may have a hardness 50-90 Shore D, such as 65-85 Shore D, as measured according to ISO 868. The at least one foamed layer may have a thickness of 2-14 mm, such as 3-8 mm, preferably 4-7 mm.

The substrate may have a thickness of 2-18 mm, such as 3-12 mm, preferably 4-8 mm.

Measurements of density, bending modulus, bending strength, hardness, and thickness described above are measured after pressing.

The at least one foamed layer may comprise 20-50 wt % of the thermoplastic material, 30-70 wt % filler, 1-10 wt % stabilizer, 0.5-7 wt % lubricant, 1-5 wt % modifier, 0.1-2 wt % blowing agent.

The at least one foamed layer may further comprise plasticizers.

The at least one foamed layer may further comprise other additives, such as processing aids, impact modifiers, pigments, fire retardants, smoke suppressants, UV-stabilisers, and/or antioxidants.

Although mentioned in singular, any reference to a term, such a thermoplastic material, also includes one or more, such as one or more thermoplastic materials, etc.

According to a second aspect of the present disclosure, a building panel comprising a substrate produced according to the method of the first aspect is provided. The building panel may be a floor panel, a wall panel, a furniture component, a building component, or a worktop.

The at least one foamed layer of the substrate may form at least one foamed layer of the building panel.

According to a third aspect of the present disclosure, a method to produce a substrate comprising at least one foamed layer is provided. The method comprises:
compounding a thermoplastic material and a blowing agent to a compounded material,
applying the compounded material comprising the thermoplastic material and the blowing agent on a carrier,
applying heat and pressure in a pressing device to the compounded material to form the at least one foamed layer,
wherein the blowing agent has an activation temperature being higher than processing temperatures for compounding the thermoplastic material and the blowing agent to the compounded material.

Compounding may be an extrusion process or similar kneading process.

The blowing agent may have a decomposition temperature being higher than processing temperatures for compounding the thermoplastic material and the blowing agent to the compounded material.

The disclosure above relating to the first aspect is applicable also for the third aspect.

### BRIEF DESCRIPTION OF THE DRAWINGS

The present disclosure will by way of example be described in more detail with reference to the appended schematic drawings, which show examples of the present disclosure.

FIG. 1 shows a first example of a method to produce a substrate.

FIG. 2 shows a second example of a method to produce a substrate.

FIG. 3 shows a first example of a building panel including a substrate.

FIG. 4 shows a second example of a building panel including a substrate.

FIG. 5 shows a third example of a building panel including a substrate.

FIG. 6 shows a fourth example of a building panel including a substrate.

FIG. 7 shows a flow chart of an example of a method to produce a substrate.

### DETAILED DESCRIPTION

A method to produce a substrate will now be described. The substrate is formed by a compounded material, such as compounded pellets or particles obtained by compounded pellets. The compounded material is formed in a compounding process.

The compounding process may be an extrusion process or similar kneading process. In the compounding process, the material may be processed in an at least partly molten or gelled state. The material may be subjected to a shear treatment, such as subjected to shear forces, in the compounding process.

In one example, a thermoplastic material is mixed with at least a blowing agent to a dry-blend, for example mixed in a hot/cold mixer. In an example, the mixing is performed at a temperature up to 120° C. and then cooled until at least 50° C.

Mixing may be performed in the extruder, particularly when the thermoplastic material is polyolefin.

As an alternative to mixing to a dry-blend, the blowing agent may be added to the thermoplastic material in the extruder, such as added through a side feeder of the extruder, such as a gravimetric side feeder.

The thermoplastic material may be PVC, PE, PP, PE, PET, TPU, PVAc, PVB, or a combination thereof. The thermoplastic material may be a recycled thermoplastic material, and/or bio-based thermoplastic material. A portion of the thermoplastic material may a recycled thermoplastic material and/or a bio-based thermoplastic material.

If the thermoplastic material is or comprise PVC, PVC may be suspension PVC, for example having a K-value of 50-90.

The blowing agent may be chosen from the group of azo compounds, hydrazine derivates, semicarbazides, tetrazoles, nitroso compounds, carbonates and expandable microspheres, and a combination thereof. The blowing agent may be an exothermic blowing agent. In one example, the blowing agent is an azo compound.

The blowing agent may be chosen such that the activation temperature is suitable in view of processing temperature during compounding and/or pressing temperature.

The dry-blend may further comprise fillers, such as inorganic and/or organic fillers. The inorganic filler may be a mineral material, for example CaCO₃, talc, fly ash, or a stone material, such as stone powder. Examples of CaCO₃ may be marble, limestone or chalk. The organic filler may a wood material, a bamboo material, cork, or rice husks. For example, the wood material may be wood fibres, wood flour and/or wood dust, and the bamboo material may be bamboo dust.

In an example without dry-blend mixing, fillers of the above described types may be added to the thermoplastic material in the extruder, or similar kneading devices.

The dry-blend may further comprise additives. Example of additives are plasticizers, coupling agents, modifiers, lubricants, stabilizers, process aids, pigments, and UV absorbents. The stabilizer may be or comprise a calcium-organic stabiliser, such as a calcium-zinc stabilizer. Zinc compounds may function as a catalyst for the blowing agent.

In an example without dry-blend mixing, additives of the above described types may be added to the thermoplastic material in the extruder, or similar kneading devices.

The dry-blend is conveyed to an extruder. In the example without prior mixing, the thermoplastic material, the blowing agent, and optionally additives and optionally fillers, are conveyed into the extruder.

Consequently, the material to be compounded comprises the thermoplastic material, the blowing agent, optionally additives and optionally fillers.

As an alternative to an extruder, a kneading device may be used.

In the compounding process, the dry-blend, or the thermoplastic material with the blowing agent and optional fillers and/or additives, is compounded to a compounded material.

The dry-blend, or the thermoplastic material with the blowing agent and optional fillers and/or additives, may be processed to an at least partly molten or gelled state in the compounding process.

In the compounding process, such as an extrusion process or kneading process, the material is subjected to a shear treatment, such as subjected to shear forces, to obtain the compounded material.

Further, in the compounded process, the material may be subjected to pressure, such as subjected to pressing forces.

An example of a recipe is found in Table 1.

The extruder may be a twin screw extruder. Other any other type of extruder may be used, such as a two-step extruder, kneader, continuous mixer, planetary roller extruder, etc. The extruder may comprise a die, through which the material leaves the extruder.

Processing temperatures of the compounding process, such as an extrusion process, are below an activation temperature of the blowing agent. Thereby, the blowing agent is not activated, or is at least not substantially activated, during the compounding process, such as the extrusion process. A majority of the foaming capacity of the blowing agent remains intact after the compounding process, such as the extrusion process.

In examples, processing temperatures of the compounding process, are at least below a decomposition temperature of the blowing agent. Thereby, the blowing agent is at least not substantially activated during the compounding process, such as the extrusion process.

The processing temperatures of the compounding process, such as the extrusion process, may, for example, be less than 230° C., such as less than 200° C.

The processing temperatures of the compounding process, such as the extrusion process may, for example, exceed 120° C.

The processing temperatures of the compounding process, such as the extrusion process may, for example, be 130-230° C., such as 130-200° C.

In an example wherein the thermoplastic material to be compounded comprises PVC and/or PVAc, the processing temperatures of the compounding process, such as the extrusion process, may be less than 200° C. In the example wherein the thermoplastic material to be compounded comprises PVC and/or PVAc, the blowing agent may be an azo compound such as azodicarbonamide (ADC), and the processing temperatures of the compounding process, such as the extrusion process, may be less than 200° C.

In an example wherein the blowing agent may be an azo compound such as azodicarbonamide (ADC) or pure azodicarbonamide (ADCA), the activation temperature may be approximately 200° C. Higher temperatures, i.e., above the decomposition temperature, increases the decomposition reaction. In the example wherein the blowing agent may be an azo compound such as azodicarbonamide (ADC) or pure azodicarbonamide (ADCA), the decomposition temperature may be approximately 215° C.

The processing temperatures indicated above is the temperature of the extrusion equipment, or similar kneading equipment. For example, the temperatures indicated above may be the temperature which the extrusion equipment, or similar kneading equipment, is set to operate at, for example, set by a person supervising the process.

The extruder extrudes a compounded material. The compounded material may be extruded through the die in form of a string of compounded material. The string of compounded material may be cut into pellets, such that compounded pellets are formed. Other methods for pelletizing are hot face pelletizing and underwater pelletizing.

The compounded pellets may have a diameter, length, and/or thickness of 0.5-8 mm, for example 0.5-5 mm, such as 1-3 mm.

The compounded pellets may be reduced in size by grinding and/or crushing the compounded pellets to a preferred particle size. The particle size may be adapted to be suitable for scattering the compounded pellets.

A reduced size of the compounded pellets may be a diameter, length, and/or thickness, of less than 3 mm.

By compounded pellets are understood to mean pellets formed of the compounded material.

The compounded material comprises at least the thermoplastic material and the blowing agent. Consequently, the compounded pellets comprise the thermoplastic material and the blowing agent.

Substantially each compounded pellet, such as at least 90% of the compounded pellets, comprises the thermoplastic material and the blowing agent.

The compounded material may in one example comprise 20-50 wt % of the thermoplastic material (or materials), 30-70 wt % filler (or fillers), 1-10 wt % stabilizer (or stabilizers), 0.5-7 wt % of lubricant (or lubricants), 1-5 wt % of modifier (modifiers), and 0.1-2 wt % of the blowing agent (or agents). Coupling agents may also be included, especially when the thermoplastic material comprises polyolefins. The compounded material may further comprise plasticizers. The compounded material may further comprise other additives, such as processing aids, impact modifiers, pigments, fire retardants, smoke suppressants, UV-stabilisers, and/or antioxidants.

### The Method May Comprise:

optionally mixing the thermoplastic material, the blowing agent and optional additives and fillers into a dry-blend;
extruding the thermoplastic material, including the blowing agent and optional additives and fillers, into a compounded material comprising at least the thermoplastic material and the blowing agent;
pelletizing the compounded material into compounded pellets;
optionally reducing the compounded pellets into size, thereby forming particles obtained by compounded pellets.

By compounding, such as extruding, the compounded material at processing temperatures below the activation temperature of the blowing agent, the foaming capacity of the blowing agent is not activated, or is substantially not activated, during the compounding process, such as the extrusion process. By substantially not activated means that less than 10% of the blowing agent is activated. By compounding the material including the blowing agent therein, the blowing agent will be uniformly distributed, or at least substantially uniformly distributed, through the compounded material, such that a uniform foaming can be obtained in a subsequent activation step. The blowing agent will be well dispersed in the compounded material.

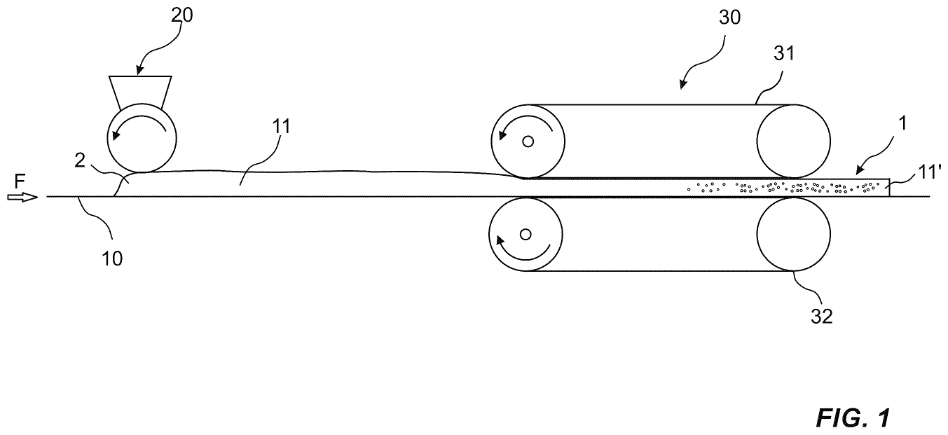

In a subsequent method, shown in FIG. 1, the compounded material 2, for example in form of the compounded pellets or particles obtained from the compounded pellets, are applied on a carrier 10 moving in a feeding direction F. The method may be performed at a later occasion or subsequent the extrusion process. The compounded material can be produced at a different site than the subsequent method.

The carrier 10 may be a conveyor such as a conveyor belt. The compounded pellets 2, or particles obtained from the compounded particles, are scattered or strewn on the carrier 10 by a scattering device 20.

The compounded material 2, in form of the compounded pellets or particles obtained from the compounded pellets, are strewn into a layer 11 of the compounded material 2 on the carrier 10. The layer 11 is pressed in a pressing device, such as a double belt press 30 as shown in FIG. 1. The pressing device is configured for continuous pressing. In one example, the compounded material 2, such as the compounded pellets or the particles obtained from the compounded pellets, may be pre-heated before entering the pressing device.

Pre-heating may involve increasing the temperature of the compounded material 2 prior to entering the pressing device 30, such as increasing an original temperature of the compounded material 2 to a temperature being higher than the original temperature, for example, to a temperature being higher than room temperature. In examples, the temperature of the compounded material 2 may be increased by 60° C., by 80° C., or by 100° C.

The pre-heating temperature may be less than the activation temperature of the blowing agent.

The compounded material 2 may be pre-heated, for example, by IR heating, hot air, rotary furnace, funnel furnace, or conveyor furnace.

Pre-heating the compounded material 2 before entering the pressing device may reduce the pressing time in the pressing device. If a continuous pressing device is used, line-speed of the pressing line may be increased by pre-heating the compounded material 2 prior to applying pressure. The double belt press 30 comprises an upper press belt 31 and a lower press belt 32. The press belts may be made of steel, or may be Teflon® coated. The double belt press 30 may be isochoric, isobaric, or may use pressured nip rollers.

The double belt press 30 applies pressure and heat to the layer 11 such that the layer 11 of the compounded material, such as the compounded pellets or particles formed by compounded pellets, are pressed into at least one foamed layer 11′, which in the example shown in FIG. 1 forms the substrate 1 itself.

By applying heat above the activation temperature of the blowing agent, the substrate will be foamed during, and/or after, pressing such that a foamed substrate 1 is formed.

The pressing temperature may be at least above the activation temperature of the blowing agent.

In examples, the pressing temperature may be above the decomposition temperature of the blowing agent.

Heat applied during pressing, i.e., the pressing temperature, may exceed 200° C., such as exceed 230° C. In on example, the pressing temperature may be in the range of 200-260° C., such as 225-250° C., for example 235-250° C. Pressure applied during pressing may be in the range of 0.5-20 bar, such as 3-10 bar. Line speed in the double belt press may be 1-15 m/min, such as 5-10 m/min. Residence time at elevated temperature may be 1-3 min, such as 1.5-2 min.

The pressing temperatures indicated is the temperature of the pressing device 30, such as the temperature of the heating elements and/or press plates, or similar. For example, the temperature indicated above may be the temperature which the pressing device is set to operate at, for example, set by a person supervising the process.

In an example wherein the compounded thermoplastic material comprises PVC and/or PVAc, the pressing temperature may exceed 200° C. In other examples, the pressing temperature may exceed 215° C. In other examples, the pressing temperature may exceed 230° C.

The pressing device 30 may comprise at least one heating zone and at least one pressing zone.

The pressing device 30 may further comprise at least one cooling zone. The cooling zone may be located downstream the at least one heating zone and the at least one pressing zone.

The layer 11 of the compounded material 2, such as the compounded pellets or the particles obtained from the compounded pellets, is pressed into a substrate 1, as shown in FIG. 1. The substrate 1 is formed in a continuous pressing process.

As the pressing temperature is above the activation temperature of the blowing agent, the substrate 1 is foamed during and/or after pressing. The substrate 1 may be uniformly foamed, or substantially uniformly foamed.

As the pressing temperature is above the activation temperature of the blowing agent, such as above the decomposition temperature, the blowing agent begins to react during pressing. The blowing agent may decompose when exposed to a temperature above the activation temperature of the blowing agent.

The foaming may be initiated during pressing. Gaseous products may be released by the chemical reaction of the blowing agent, thereby forming bubbles. When the pressure is released, the bubbles can expand such as a foamed structure is obtained.

The foaming reaction may be terminated by conveying the substrate 1 into a cooling zone (not shown).

Further, the substrate 1 may be conveyed through a pair of rollers (not shown). Thereby, the thickness of the substrate 1 may be uniformed. The foamed structure may be uniformed by passing through the pair of rollers.

After pressing, the substrate 1 may have a thickness of 2-14 mm, such as 3-8 mm, for example 4-7 mm.

In the example shown in FIG. 1, a single foamed layer 11′ is formed. The single foamed layer 11′ forms the substrate 1.

The foamed layer 11′ may also be referred to as a first foamed layer 11′.

The foamed layer 11′, and in the example of FIG. 1 the substrate 1, may have a density of 1.0-1.9 kg/dm³, such as 1.2-1.8 kg/dm³, for example 1.4-1.8 kg/dm³, as measured according to ISO 1183.

Density is measured after pressing.

After pressing, edges of the substrate 1 may be trimmed. The substrate 1 may further be cut into boards to a desired length and/or size. The width of the boards may correspond to the width of the substrate 1. The length of the boards may be less than a length of the substrate 1. The boards may be further cut into panels.

After pressing, the substrate 1 may be annealed in an annealing process.

By forming the foamed layer 11′, and in the example shown in FIG. 1 the substrate 1 formed by the foamed layer 11′, from the compounded material in form of the compounded pellets 2, or the particles obtained from the compounded pellets, the substrate 1 obtains a uniform, or substantially uniform, foaming after pressure. The foaming capacity of the blowing agent remains intact, or substantially intact, after the compounding process as the processing temperatures of the compounding process are below the activation temperature of the blowing agent. By forming the substrate 1 from the compounded material, the substrate 1 obtains improved mechanical properties although having a reduced density due to foaming.

It has been shown that the foamed layer may be denser, and may have higher density, higher bending strength and higher modulus than other conventionally produced foamed substrates.

Further, the foamed layer may be non-directional, which is typically not the case conventional extruding or calendering. Properties over the width of the substrate may be more uniform and stable compared to conventional extruding, such as WPC (Water Proof Core or Wood Plastic Composite) and EPC (Expanded Polymer Core).

The manufacturing capacity can be higher compared to a one step process. The line speed of a double belt press is higher than a conventional extruder. A double belt press can have a capacity exceeding 10 m/min, compared to a conventional extruder that can run up to 3 m/min. The capacity of a compounder can be very high depending on the size. A double belt press can also be wider, thereby producing substrate having a width exceeding a width of an extruded substrate.

Further, the method offers an improved possibility to produce multi-layered substrates compared to a conventional extruder. The method offers a greater flexibility in processing different materials in the same machinery, better control of individual press parameters, constant quality, and a high degree of automation.

The double belt press provides the efficiency of a continuous process.

For example, the foamed layer 11′, and in the example of FIG. 1 the substrate 1, may have a bending modulus of 2000-7000 N/mm², such as preferably 3000-6000 N/mm², as measured according to ISO 178. The foamed layer 11′, and in the example of FIG. 1 the substrate 1 may have a bending strength of 10-50 N/mm², such as 18-35 N/mm², as measured according to ISO 178. The foamed layer 11′, and in the example of FIG. 1 the substrate 1, may have a hardness 50-90 Shore D, such as 65-85 Shore D, as measured according to ISO 868.

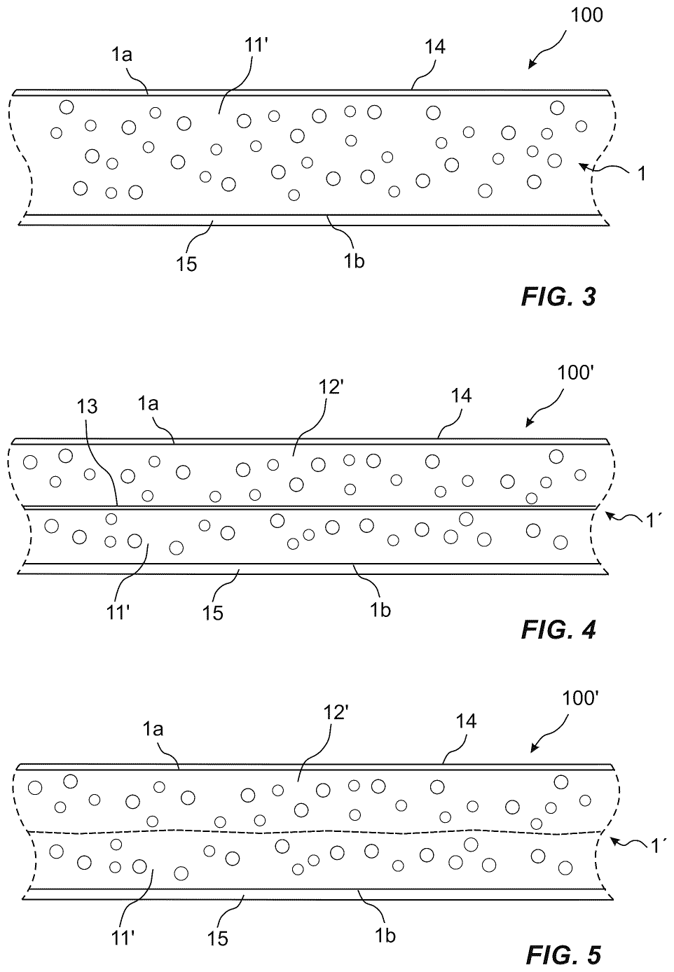

Since the at least one foamed layer 11′ forms the substrate 1 itself in the example shown in FIGS. 1 and 3, the disclosure above relating to the substrate 1 also defines the at least one foamed layer 11′, and vice versa, for the example in FIGS. 1 and 3.

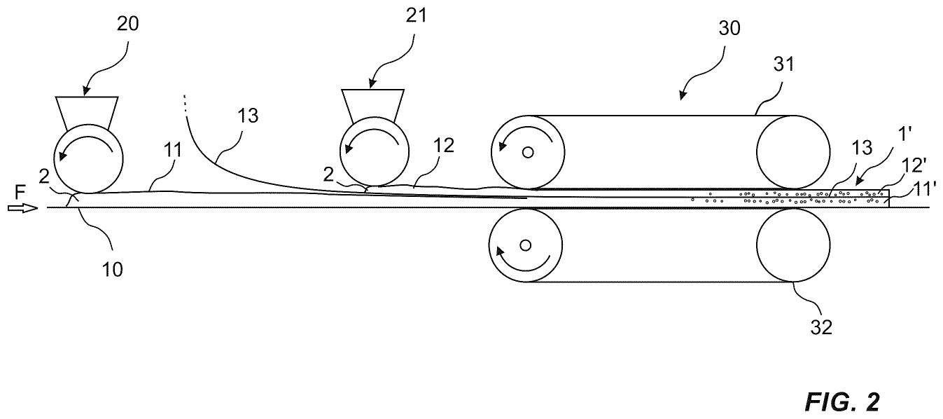

A second example of a method to form at least one foamed layer is shown in FIG. 2. In the following, only the differences between the method disclosed with reference to FIG. 1 and the method disclosed with reference to FIG. 2 will be discussed. In all other aspects, the method described with reference to FIG. 2 corresponds to the method described above with reference to FIG. 1.

In FIG. 2, the above described compounded material 2, for example in form of the compounded pellets or the particles obtained from the compounded pellets, are applied, such as strewn or scattered, on the carrier 10 by a first scattering device 20.

The compounded material 2, for example the compounded pellets or particles obtained from the compounded pellets, are strewn into a first layer 11 of the compounded material 2 on the carrier 10.

A reinforcement layer 13 is applied on the first layer 11. The reinforcement layer 13 may be a non-woven or a woven structure. The reinforcement layer 13 may be fibre reinforced sheet. The fibres may be organic and/or inorganic fibres. The fibres may be chosen from the group of natural fibres, glass fibres, polymer fibres, mineral-based fibres, carbon fibres, and a combination thereof. The fibres may be randomly distributed, such as in a chopped strand mat. The fibres may be woven into a woven, or may be a non-woven.

The fibres may be embedded in a polymer matrix to form the reinforcement layer 13. The polymer matrix may comprise a thermosetting polymer such as epoxy, polyester, and/or vinyl ester. The polymer matrix may comprise a thermoplastic polymer.

The reinforcement layer 13 may be or comprise a glass fibre layer.

The reinforcement layer 13 may have a thickness of 0.1-2 mm, such as 0.3-1 mm.

The above described compounded material 2, such as the compounded pellets or the particles obtained from the compounded pellets, are applied, such as strewn or scattered, on the reinforcement layer 13 by a second scattering device 21. The compounded material 2, such as the compounded pellets or particles obtained from the compounded pellets, are strewn into a second layer 12 of the compounded material 2 on the reinforcement layer 13.

The composition of the compounded material 2 of the first layer 11 may be different from the composition of the compounded material 2 of the second layer 12. For example, the amount of blowing agent in the compositions may vary, such as the amount of blowing agent in the first layer exceeds the amount of blowing agent in the second layer, or vice versa.

In other examples, the composition of the compounded material 2 of the first layer 11 substantially corresponds to the composition of the compounded material 2 of the second layer 12.

In other examples, the reinforcement layer 13 is optional. In such examples, the compounded material 2, such as the compounded pellets or particles obtained from the compounded pellets, are strewn into a second layer 12 of the compounded material 2 on the first layer 11 of the compounded material 2, without any intervening layer.

The first layer 11, the reinforcement layer 13, and the second layer 12 are conveyed to the pressing device, such as the double belt press 30 as described above with reference to FIG. 1. After pressing, a substrate 1′ is formed, comprising a first foamed layer 11′, the reinforcement layer 13, and a second foamed layer 12′.

The substrate 1′ is formed in a continuous pressing process.

The pressing device 30 applies pressure and heat to the first layer 11 such that the first layer 11 of the compounded material 2 is pressed into the first foamed layer 11′. Similarly, the pressing device 30 applies pressure and heat to the second layer 12 such that the second layer 12 of the compounded material 2 is pressed into the second foamed layer 12′. The reinforcement layer 13 is arranged between the first and the second foamed layer 11′, 12′.

After pressing, the substrate 1′ may have a thickness of 2-18 mm, such as 3-8 mm, for example 4-8 mm. The first foamed layer 11′ and/or the second foamed layer 12′ may each have a thickness of 2-14 mm, such as 3-8 mm, preferably 4-7 mm.

After pressing, the thickness of the first foamed layer 11′ may be in the range of 1:4 to 1:1 of the thickness of the second foamed layer 12′.

In another example, after pressing, the thickness of the second foamed layer 12′ may be in the range of 1:4 to 1:1 of the thickness of the first foamed layer 11′.

The first foamed layer 11′ and/or the second foamed layer 12′ may have a density of 1.0-1.9 kg/dm³, such as 1.2-1.8 kg/dm³, for example 1.4-1.8 kg/dm³, as measured according to ISO 1183.

Density is measured after pressing, i.e., the foamed layer, or layers, are measured.

As discussed above, by forming the substrate 1′ from the compounded material 2, such as in form of the compounded pellets or the particles obtained from the compounded pellets, the substrate 1′ obtains uniform, or substantially uniform, foaming after pressure. The foaming capacity of the blowing agent remains intact, or substantially intact, after the compounding process as the processing temperatures of the compounding process are below the activation temperature of the blowing agent. By forming the substrate 1′ from the compounded material, the substrate 1 obtains improved mechanical properties although having a reduced density due to foaming.

It has been shown that the foamed layer may be denser, and may have higher density, higher bending strength and higher modulus than other conventionally produced foamed substrates, such as WPC (Wood Plastic Core) and EPC (Expanded Polymer Core).

Further, the foamed layers may be non-directional, which is typically not the case conventional extruding or calendering. Properties over the width of the foamed layers may be more uniform and stable compared to conventional extruding.

The manufacturing capacity can be higher compared to a one step process. The line speed of a double belt press is higher than a conventional extruder. A double belt press can have a capacity exceeding 10 m/min, compared to a conventional extruder that can run up to 3 m/min. The capacity of a compounder can be very high depending on the size. A double belt press can also be wider, thereby producing substrate having a width exceeding a width of an extruded substrate.

Further, the method offers an improved possibility to produce multi-layered substrates compared to a conventional extruder. The method offers a greater flexibility in processing different materials in the same machinery, better control of individual press parameters, constant quality, and a high degree of automation.

The double belt press provides the efficiency of a continuous process.

For example, the substrate 1′ and/or at least one of the first and second foamed layers 11′, 12′ may have a bending modulus of 2000-7000 N/mm², such as preferably 3000-6000 N/mm², as measured according to ISO 178. The substrate 1′ and/or at least one of the first and second foamed layers 11′, 12′ may have a bending strength of 10-50 N/mm², such as 18-35 N/mm², as measured according to ISO 178. At least one of the first and second foamed layers 11′, 12′ may have a hardness 50-90 Shore D, such as 65-85 Shore D, as measured according to ISO 868.

In one example, the foaming rate may vary between the first foamed layer 11′ and the second foamed layer 12′.

In one example, the reinforcement layer 13 is excluded, such that the second layer 12 is applied on the first layer 11. After pressing, the second foamed layer 12′ is arranged on the first foamed layer 11′, such as arranged directly on the first foamed layer 11′.

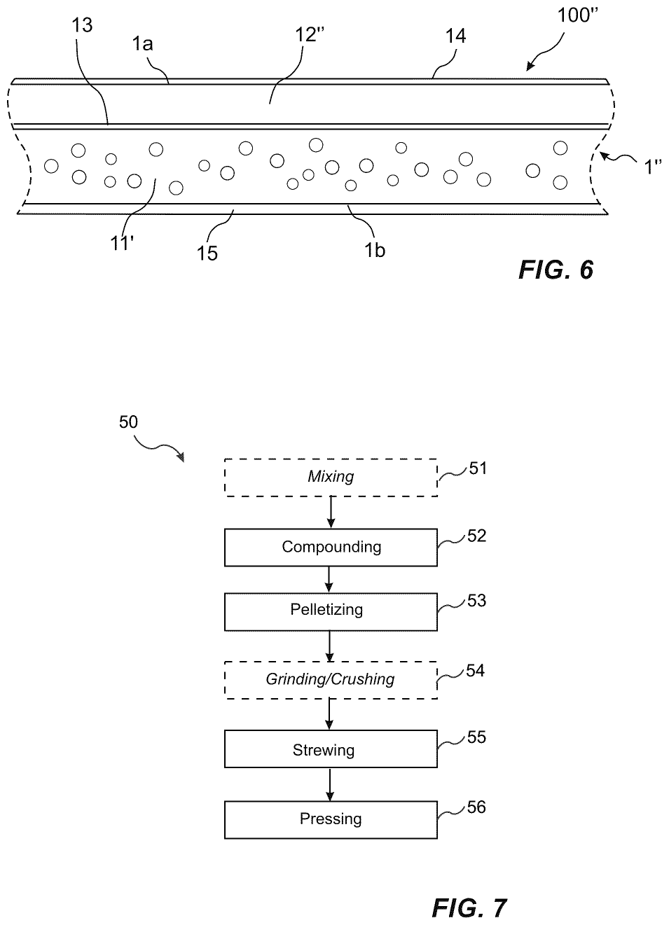

In the example described above with reference to FIG. 2, the substrate 1′ comprises two foamed layers 11′, 12′. However, in other examples, at least one layer is foamed and at least one layer is unfoamed. For example, at least one layer may be formed by a compounded material being free from any blowing agent, and at least one layer is formed by the compounded material described above, comprising a blowing agent. Such a substrate will be described with reference to FIG. 6 below.

In examples, the substrate 1′ comprises the two foamed layers 11′, 12′ and the foaming rate between the two foamed layers 11′, 12′ may vary, which will be described below with reference to FIGS. 4 and 5.

FIG. 3 shows an example of a building panel 100 comprising a substrate 1. The substrate 1 may be produced by the method described above with reference to FIG. 1. The substrate 1 is formed by the foamed layer 11′, such that the substrate 1 in one example consists of the foamed layer 11′.

The building panel 100 may be a floor panel, a wall panel, a furniture component, a building component, a worktop, etc.

The example of the building panel 100 illustrated in FIG. 3 further comprises a surface layer 14 attached to a first surface 1a of the substrate 1. The surface layer 14 may comprise a printed thermoplastic film and a protective layer such as a thermoplastic wear layer and/or a coating. A backing layer 15, such as a foamed underlayer, may be attached to a second surface 1b of the substrate 1. If the building panel 100 is configured to form a flooring panel, the second surface 1b of the substrate 1 may be configured to face a sub-floor when installed.

The building panel 100 may be provided with a mechanical locking system along at least edge to join the building panel 100 to an adjacent building panel.

The foamed layer 11′ may be substantially uniformly foamed.

The substrate 1 may have a thickness of 2-14 mm, such as 3-8 mm, for example 4-7 mm. The foamed layer 11′, and in the example of FIG. 3 the substrate 1, may have a density of 1.0-1.9 kg/dm³, such as 1.2-1.8 kg/dm³, for example 1.4-1.8 kg/dm³, as measured according to ISO 1183.

The foamed layer 11′, and in the example of FIG. 3 the substrate 1, may have a bending modulus of 2000-7000 N/mm², such as preferably 3000-6000 N/mm², as measured according to ISO 178. The foamed layer 11′, and in the example of FIG. 3 the substrate 1, may have a bending strength of 10-50 N/mm², such as 18-35 N/mm², as measured according to ISO 178. The foamed layer 11′, and in the example of FIG. 3 the substrate 1, may have a hardness 50-90 Shore D, such as 65-85 Shore D, as measured according to ISO 868.

The thermoplastic material of the foamed layer 11′ may be or comprise PVC, PE, PP, PE, PET, TPU, PVAc, PVB, or a combination thereof. The thermoplastic material may be or comprise a recycled thermoplastic material, and/or bio-based thermoplastic material. The foamed layer 11′ may further comprise additives such as plasticizers, coupling agents, modifiers, lubricants, stabilizers, process aids, pigments, and UV absorbents. The foamed layer 11′ may further comprise filler such as such as inorganic and/or organic fillers. The inorganic filler may be a mineral material, for example CaCO₃, talc, fly ash, or a stone material, such as stone powder. Examples of CaCO₃ may be marble, limestone or chalk. The organic filler may a wood material, a bamboo material, cork, or rice husks. For example, the wood material may be wood fibres, wood flour and/or wood dust, and the bamboo material may be bamboo dust.

FIGS. 4 and 5 show further examples of a building panel 100′ comprising a substrate 1′. The substrate 1′ may be produced by the method described above with reference to FIG. 2. The substrate 1′ is formed by the first foamed layer 11′, the second foamed layer 12′, and, in the example of FIG. 4, the reinforcement layer 13 arranged therebetween.

In the example illustrated in FIG. 5, the reinforcement layer 13 is optional, such that the substrate 1′ is formed by the first foamed layer 11′ and the second foamed layer 12′. The second foamed layer 12′ may be arranged on the first foamed layer 11′ without any intervening reinforcement layer 13, which is illustrated in FIG. 5.

In the example wherein the second foamed layer 12′ is arranged on the first foamed layer 11′, without any intervening layer, the boundary between the first foamed layer 11′ and the second foamed layer 12′ may be less distinct, which is illustrated by a dashed line in FIG. 5. In other aspects, the example illustrated in FIG. 5 corresponds to the example described with reference to FIG. 4.

The building panel 100′ may be a floor panel, a wall panel, a furniture component, a building component, a worktop, etc.

The example of the building panel 100′ illustrated in FIGS. 4 and 5 further comprises a surface layer 14 attached to a first surface 1a of the substrate 1′. The surface layer 14 may comprise a printed thermoplastic film and a protective layer such as a thermoplastic wear layer and/or a coating. A backing layer 15, such as a foamed underlayer, may be attached to a second surface 1b of the substrate 1′. If the building panel 100′ is configured to form a flooring panel, the second surface 1b of the substrate 1′ may be configured to face a sub-floor when installed.

The building panel 100′ may be provided with a mechanical locking system along at least edge to join the building panel 100′ to an adjacent building panel.

The first foamed layer 11′ and/or the second foamed layer 12′ may have a thickness of 2-10 mm, such as 3-8 mm, for example 4-7 mm. The substrate 1′ in total may have a thickness of 2-18 mm, such as 3-12 mm, preferably 4-8 mm.

The thickness of the first foamed layer 11′ may be in the range of 1:4 to 1:1 of the thickness of the second foamed layer 12′.

In another example, the thickness of the second foamed layer 12′ may be in the range of 1:4 to 1:1 of the thickness of the first foamed layer 11′.

The first foamed layer 11′ and/or the second foamed layer 12′ may have a density of 1.0-1.9 kg/dm³, such as 1.2-1.8 kg/dm³, for example 1.4-1.8 kg/dm³, as measured according to ISO 1183.

The substrate 1′ in total may have a density of 1.2-2 kg/dm³ as measured according to ISO 1183.

The first foamed layer 11′ and/or the second foamed layer 12′ may have a bending modulus of 2000-7000 N/mm², such as preferably 3000-6000 N/mm², as measured according to ISO 178.

The substrate 1′ in total may have a bending modulus of 2000-11000 N/mm², as measured according to ISO 178.

The first foamed layer 11′ and/or the second foamed layer 12′ may have a bending strength of at least 10 N/mm², such as 10-50 N/mm², for example 18-35 N/mm², as measured according to ISO 178.

The substrate 1′ in total may have a bending strength of at least 10 N/mm², such as 10-60 N/mm², for example 18-50 N/mm², as measured according to ISO 178. The first foamed layer 11′ and/or the second foamed layer 12′ may have a hardness 50-90 Shore D, such as 65-85 Shore D, as measured according to ISO 868.

In one example, the foaming rate may vary between the first foamed layer 11′ and the second foamed layer 12′.

The composition of the first foamed layer 11′ may be different from the composition of the second foamed layer 12′. In other examples, the compositions may be essentially similar.

In the example illustrated in FIG. 5, the reinforcement layer 13 is excluded, such that the second layer 12 is applied on the first layer 11. The second foamed layer 12′ may be arranged directly on the first foamed layer 11′.

The reinforcement layer 13, if present, may be a non-woven or a woven structure. The reinforcement layer 13 may be fibre reinforced sheet. The fibres may be organic and/or inorganic fibres. The fibres may be chosen from the group of natural fibres, glass fibres, polymer fibres, mineral-based fibres, carbon fibres, and a combination thereof. The fibres may be randomly distributed, such as in a chopped strand mat. The fibres may be woven into a woven, or may be a non-woven.

The fibres may be embedded in a polymer matrix to form the reinforcement layer 13. The polymer matrix may comprise a thermosetting polymer such as epoxy, polyester, and/or vinyl ester. The polymer matrix may comprise a thermoplastic polymer.

The reinforcement layer 13 may be or comprise a glass fibre layer.

The thermoplastic material of the first foamed layer 11′ and/or the second foamed layer 12′ may be or comprise PVC, PE, PP, PE, PET, TPU, PVAc, PVB, or a combination thereof. The thermoplastic material may be or comprise a recycled thermoplastic material, and/or bio-based thermoplastic material. The first foamed layer 11′ and/or the second foamed layer 12′ may further comprise additives such as plasticizers, coupling agents, modifiers, lubricants, stabilizers, process aids, pigments, and UV absorbents. The first foamed layer 11′ and/or the second foamed layer 12′ may further comprise filler such as such as inorganic and/or organic fillers. The inorganic filler may be a mineral material, for example CaCO₃, talc, fly ash, or a stone material, such as stone powder. Examples of CaCO₃ may be marble, limestone or chalk. The organic filler may a wood material, a bamboo material, cork, or rice husks. For example, the wood material may be wood fibres, wood flour and/or wood dust, and the bamboo material may be bamboo dust.

FIG. 6 shows a third example of a building panel 100″ comprising a substrate 1″. The substrate 1″ may be produced by the method described above with reference to FIG. 2 with some modifications. The substrate 1″ is formed by the first foamed layer 11′, a second unfoamed layer 12″, and the reinforcement layer 13 arranged therebetween.

In another example, the reinforcement layer 13 is optional, such that the substrate 1″ is formed by the first foamed layer 11′ the second unfoamed layer 12″. The second unfoamed layer 12″ may be arranged on the first foamed layer 11′ without any intervening reinforcement layer 13, similarly as illustrated in FIG. 5.

The first foamed layer 11′ may be formed in accordance with the method described above with reference to FIG. 2. The first foamed layer 11′ may be formed by the first layer 11 of the compounded pellets 2 including the blowing agent, as described above.

The second unfoamed layer 12″ may be formed by a layer of a compounded material being free from any blowing agent. The second unfoamed layer 12″ may be applied on the reinforcement layer 13, or directly on the first foamed layer 11′.

The composition of the unfoamed layer 12″ may be different from the composition of the first foamed layer 11′.

The building panel 100″ may be a floor panel, a wall panel, a furniture component, a building component, a worktop, etc.

The example of the building panel 100″ illustrated in FIG. 6 further comprises a surface layer 14 attached to a first surface 1a of the substrate 1″. The surface layer 14 may comprise a printed thermoplastic film and a protective layer such as a thermoplastic wear layer and/or a coating. A backing layer 15, such as a foamed underlayer, may be attached to a second surface 1b of the substrate 1″. If the building panel 100″ is configured to form a flooring panel, the second surface 1b of the substrate 1″ may be configured to face a sub-floor when installed.

The building panel 100″ may be provided with a mechanical locking system along at least edge to join the building panel 100″ to an adjacent building panel.

The substrate 1″ in total may have a thickness of 2-18 mm, such as 3-12 mm, preferably 4-8 mm. The first foamed layer 11′ may have a thickness of 2-14 mm, such as 3-8 mm, preferably 4-7 mm. The first foamed layer 11′ may have a density of 1.0-1.9 kg/dm³, such as 1.2-1.8 kg/dm³, for example 1.4-1.8 kg/dm³, as measured according to ISO 1183. The substrate 1″ in total may have a density of 1.2-2 kg/dm³ as measured according to ISO 1183.

The thickness of the first foamed layer 11′ may be in the range of 1:4 to 1:1 of the thickness of the second foamed layer 12″.

In another example, after pressing, the thickness of the second foamed layer 12″ may be in the range of 1:4 to 1:1 of the thickness of the first foamed layer 11′.

The first foamed layer 11′ may have a bending modulus of 2000-7000 N/mm², such as preferably 3000-6000 N/mm², as measured according to ISO 178. The first foamed layer 11′ may have a bending strength of 10-50 N/mm², such as 18-35 N/mm², as measured according to ISO 178. At least the first foamed layer 11′ may have a hardness 50-90 Shore D, such as 65-85 Shore D, as measured according to ISO 868.

The substrate 1″ in total may have a bending modulus of 2000-11000 N/mm² as measured according to ISO 178. The substrate 1″ in total may have a bending strength of at least 10 N/mm², such as 10-60 N/mm², for example 18-50 N/mm², as measured according to ISO 178.

In another example (not shown), the reinforcement layer 13 is excluded, such that the second layer 12 is applied on the first layer 11. The foamed layer 12″ may be arranged on the first foamed layer 11′, such as arranged directly on the first foamed layer 11′.

The reinforcement layer 13 may be a non-woven or a woven structure. The reinforcement layer 13 may be fibre reinforced sheet. The fibres may be organic and/or inorganic fibres. The fibres may be chosen from the group of natural fibres, glass fibres, polymer fibres, mineral-based fibres, carbon fibres, and a combination thereof. The fibres may be randomly distributed, such as in a chopped strand mat. The fibres may be woven into a woven, or may be a non-woven.

The fibres may be embedded in a polymer matrix to form the reinforcement layer 13. The polymer matrix may comprise a thermosetting polymer such as epoxy, polyester, and/or vinyl ester. The polymer matrix may comprise a thermoplastic polymer.

The reinforcement layer 13 may be or comprise a glass fibre layer.

The thermoplastic material of the first foamed layer 11′ and/or the second unfoamed layer 12″ may be or comprise PVC, PE, PP, PE, PET, TPU, PVAc, PVB, or a combination thereof. The thermoplastic material may be or comprise a recycled thermoplastic material, and/or bio-based thermoplastic material. The first foamed layer 11′ and/or the second unfoamed layer 12″ may further comprise additives such as plasticizers, coupling agents, modifiers, lubricants, stabilizers, process aids, pigments, and UV absorbents. The first foamed layer 11′ and/or the second unfoamed layer 12″ may further comprise filler such as such as inorganic and/or organic fillers. The inorganic filler may be a mineral material, for example CaCO₃, talc, fly ash, or a stone material, such as stone powder. Examples of CaCO₃ may be marble, limestone or chalk. The organic filler may a wood material, a bamboo material, cork, or rice husks. For example, the wood material may be wood fibres, wood flour and/or wood dust, and the bamboo material may be bamboo dust.

In the example shown in FIG. 6, the second unfoamed layer 12″ is arranged in an upper part of the substrate 1″, close to the surface layer 14. However, in other examples, the arrangement may be the opposite, such the second unfoamed layer is arranged in a lower part of the substrate 1″, close to the backing layer 15.

In all examples above, the surface layer 14 and the backing layer 15 are optional.

In the examples described above with reference to FIGS. 4-6, the substrate 1, 1′, 1″ comprises two layers 11′, 12′, 12″. However, the substrate may comprise more than two layers, wherein at least one layer of the substrate is foamed.

An example of the method will now be described with reference to the flow chart in FIG. 7 describing an example of the method 50 to produce a substrate comprising at least one foamed layer.

In optional step 51, the thermoplastic material is mixed with the blowing agent, and optional additives and fillers, into a dry-blend. In an alternative to step 51, the blowing agent is added to the thermoplastic material in the compounding equipment in step 52. In a further alternative, the thermoplastic material is mixed with optional additives and fillers into a dry-blend in step 51, while the blowing agent is added to the thermoplastic material in the compounding equipment in step 52.

In step 52, the thermoplastic material, the blowing agent, and optional additives and fillers, are compounded in the compounding equipment to the compounded material at processing temperatures being lower than an activation temperature of the blowing agent.

In step 53, the compounded material comprising the thermoplastic material, the blowing agent, and optional additives and fillers, are pelletized into compounded pellets at processing temperatures being lower than the activation temperature of the blowing agent.

In optional step 54, compounded pellets are reduced in size, for example by grinding and/or crushing, to particles obtained from the compounded pellets.

In step 55, the compounded pellets, or the particles obtained from the compounded pellets, are strewn or scattered on a carrier.

In step 56, a layer formed by the compounded pellets, or the particles obtained from the compounded pellets, is pressed into at least one foamed layer by applying heat and pressure at a temperature exceeding the activation temperature of the blowing agent.

It is contemplated that there are numerous modifications of the embodiments described herein, which are still within the scope of the disclosure as defined by the appended claims.

TABLE 1
Exemplary recipe

| Raw material | Type | phr | % |
|---|---|---|---|
| Norvinyl S5745 | PVC resin | 100 | 35.36% |
| Omyacarb 40 GU | CaCO₃ filler | 170 | 60.11% |
| Baeropan MC 91596 PLS-C | Ca-organic stabilizer | 5 | 1.77% |
| Paraloid K-435 | Process aid | 4 | 1.41% |
| Baerocid SMS 1A | Internal lubricant | 0.5 | 0.18% |
| Baerolub PA 200 | External lubricant | 0.5 | 0.18% |
| Fascom AZ4 | Foaming agent (ADC) | 0.8 | 0.28% |
| Addstrength CPE-3516 | Modifier | 1 | 0.27% |
| Kane Ace B580 | Modifier | 1 | 0.27% |
| Total | | 282.8 | 100% |

### EXAMPLES

### Example 1

All ingredients according to the recipe in Table 2 except the blowing agent were mixed to a dry-blend in a hot/cold mixer (Labtech Scientific Laboratory high speed mixer, type LMX25-VSFI and cooler mixer, type LCM-50). The ingredients were mixed to a dry-blend until the temperature reaches 120° C. and then cooled until the temperature reaches 50° C.

The dry-blend was then compounded using Labtech Scientific Laboratory twin-screw extruder type LTECC 26-52. The extruder is a co-rotating twin-screw compounding extruder. The blowing agent according to Table 2 was added through a gravimetric side feeder of the extruder.

The blowing agent, Fascom AZ4, which is pure azodicarbonamide (ADCA), starts to decompose, and thus starts to be activated, at approximately 200° C. Higher temperature increases the decomposition reaction.

The compounded material was thereafter cut to pellets having a thickness of 1 mm. The compounded material in form of the pellets was scattered and pressed in a double belt press to form a foamed substrate.

Extruder settings: processing temperatures of 175-180° C. in barrel and die, blowing agent in gravimetric side feeder, 400 rpm, co-rotating. Output 10 kg/h.

Double belt settings: line speed 1.1 m/min, temperature in heating elements 240° C., 240° C., 230° C., 225° C., respectively.

The resulting substrate has the following physical properties:

Density: 1474 g/dm³ as measured according to ISO 1183; Hardness 67 Shore D as measured according to ISO 868; Youngs modulus: 3144 N/mm² as measured according to ISO 178; Bending strength: 17.14 N/mm² as measured according to ISO 178; Strain at break: 2.11% as measured according to ISO 178.

TABLE 2
Recipe 273-5

| Raw material | Comment | phr |
|---|---|---|
| Norvinyl S5745 | K57 | 100 |
| Omyacarb 40 GU | CaCO₃ | 170 |
| Baeropan MC 91596 PLS-C | Ca-organic stabilizer | 5 |
| Paraloid K435 | Process aid | 4 |
| Baerocid SMS 1A | Internal lubricant | 1.5 |
| Baerolub PA 200 | External lubricant | 1.5 |
| Fascom AZ4 | Blowing agent (ADC) | 0.8 |
| Addstrength CPE-3516 | Modifier | 3 |
| Kane Ace B580 | Modifier | 1 |
| Total | | 286.8 |

### Example 2

All ingredients according to the recipe in Table 3 except the blowing agent were mixed to a dry-blend in a hot/cold mixer (Labtech Scientific Laboratory high speed mixer, type LMX25-VSFI and cooler mixer, type LCM-50). The ingredients were mixed to a dry-blend until the temperature reaches 120° C. and then cooled until the temperature reaches 50° C.

The dry-blend was then compounded using Labtech Scientific Laboratory twin-screw extruder type LTECC 26-52. The extruder is a co-rotating twin-screw compounding extruder. The blowing agent according to Table 3 was added through a gravimetric side feeder of the extruder.

The blowing agent, Fascom AZ4, which is pure azodicarbonamide (ADCA), starts to decompose, and thus starts to be activated, at approximately 200° C. Higher temperature increases the decomposition reaction.

The compounded material was thereafter cut to pellets having a thickness of 1 mm. The compounded material in form of the pellets was scattered and pressed in a double belt press to form a foamed substrate.

Extruder settings: processing temperatures of 175-180° C. in barrel and die, blowing agent in side gravimetric feeder, 400 rpm, co-rotating. Output 10 kg/h.

Double belt settings: line speed 2.5 m/min, temperatures in all four heating elements 230° C., total length of heating zone 5.3 m, pressure on nip roller 3 bar.

The resulting substrate has the following physical properties:

Density: 1590 g/dm³ as measured according to ISO 1183; Hardness: 75 Shore D as measured according to ISO 868; Youngs modulus: 4674 N/mm² as measured according to ISO 178; Bending strength: 24.23 N/mm² as measured according to ISO 178; Strain at break: 2.48% as measured according to ISO 178.

TABLE 3
Recipe 328-2

| Raw material | Type | phr | % |
|---|---|---|---|
| Norvinyl S5745 | PVC resin | 100 | 35.36% |
| Omyacarb 40 GU | CaCO3 filler | 170 | 60.11% |
| Baeropan MC 91596 PLS-C | Ca-organic stabilizer | 5 | 1.77% |
| Paraloid K-435 | Process aid | 4 | 1.41% |
| Baerocid SMS 1A | Internal lubricant | 0.5 | 0.18% |
| Baerolub PA 200 | External lubricant | 0.5 | 0.18% |
| Fascom AZ4 | Foaming agent (ADC) | 0.8 | 0.28% |
| Addstrength CPE-3516 | Modifier | 1 | 0.27% |
| Kane Ace B580 | Modifier | 1 | 0.27% |
| Total | | 282.8 | 100% |

### Example 3

All ingredients according to the recipe in Table 4 except the blowing agent were mixed to a dry-blend in a hot/cold mixer (Labtech Scientific Laboratory high speed mixer, type LMX25-VSFI and cooler mixer, type LCM-50). The ingredients were mixed to a dry-blend until the temperature reaches 120° C. and then cooled until the temperature reaches 50° C.

The dry-blend was then compounded using Labtech Scientific Laboratory twin-screw extruder type LTECC 26-52. The extruder is a co-rotating twin-screw compounding extruder. The blowing agent according to Table 4 was added through a gravimetric side feeder of the extruder.

The blowing agent, Fascom AZ4, which is pure azodicarbonamide (ADCA), starts to decompose, and thus starts to be activated, at approximately 200° C. Higher temperature increases the decomposition reaction.

The compounded material was thereafter cut to pellets having a thickness of 1 mm. The compounded material in form of the pellets was scattered and pressed in a double belt press to form a foamed substrate.

Extruder settings: processing temperatures of 175-180° C. in barrel and die, blowing agent in gravimetric side feeder, 400 rpm, co-rotating. Output 10 kg/h.

Double belt settings: line speed 1.1 m/min, temperature in heating elements 240° C., 240° C., 230° C., 225° C., respectively, total length of heating zone 2 m.

The resulting substrate has the following physical properties:

Density: 1535 g/dm³ as measured according to ISO 1183; Hardness 73 Shore D as measured according to ISO 868; Youngs modulus: 4424 N/mm² as measured according to ISO 178; Bending strength: 21.38 N/mm² as measured according to ISO 178; Strain at break: 1.53% as measured according to ISO 178.

TABLE 4
Recipe 357-1

| Raw material | Type | phr | % |
|---|---|---|---|
| Norvinyl S5745 | PVC resin | 100 | 35.36% |
| Grenaafiller | CaCO₃ filler | 170 | 60.11% |
| Baeropan MC 91596 PLS-C | Ca-organic stabilizer | 5 | 1.77% |
| Paraloid K-435 | Process aid | 4 | 1.41% |
| Baerocid SMS 1A | Internal lubricant | 0.5 | 0.18% |
| Baerolub PA 200 | External lubricant | 0.5 | 0.18% |
| Fascom AZ4 | Foaming agent (ADC) | 0.8 | 0.28% |
| Addstrength CPE-3516 | Modifier | 1 | 0.27% |
| Kane Ace B580 | Modifier | 1 | 0.27% |
| Total | | 282.8 | 100% |

### Example 4

A lab rotary IR drum was used to pre-heat the compounded material in form of compounded pellets prior to pressing. The IR drum was charged with 1500 ml pellets. The pellets were heated to 130° C. After pre-heating, the pellets were poured in to a scatter hopper and applied to a lower Teflon® belt of a pressing device via the scatter hopper. The pellet temperature directly after scattering was measured to 100° C. At heat zone entrance, the temperature has dropped to 80° C. The substrates were run through heating, pressing, and cooling zones.

In the above test, by pre-heating the pellets it was possible to increase the line speed with 45%, compared to room temperatured pellets entering into the heat zone entrance of the pressing device. By pre-heating the pellets, the time in the heat zone can be reduced, and thereby the line speed can be increased.

### Item Section

1. A method to produce a substrate (1; 1′; 1″) comprising at least one foamed layer (11′, 12′), the method comprising
applying a compounded material (2) on a carrier (10), wherein the compounded material (2) comprises a thermoplastic material and a blowing agent,
applying heat and pressure in a pressing device (30) to the compounded material (2) to form the at least one foamed layer (11′, 12′),
wherein the blowing agent has an activation temperature being higher than processing temperatures for forming the compounded material (2).
2. A method to produce a substrate comprising at least one foamed layer, the method comprising:
compounding a thermoplastic material and a blowing agent to a compounded material,
applying the compounded material comprising the thermoplastic material and the blowing agent on a carrier,
applying heat and pressure in a pressing device to the compounded material to form the at least one foamed layer,
wherein the blowing agent has an activation temperature being higher than processing temperatures for compounding the thermoplastic material and the blowing agent to the compounded material.
3. The method according to item 1 or 2, wherein applying the compounded material (2) on the carrier (10) comprises applying compounded pellets, or particles obtained from compounded pellets, on the carrier (10), wherein the compounded pellets comprise the thermoplastic material and the blowing agent,
wherein applying heat and pressure in the pressing device (30) comprises applying heat and pressure to the compounded pellets, or the particles obtained from the compounded pellets, to form the at least one foamed layer,
wherein the blowing agent has an activation temperature being higher than processing temperatures for forming the compounded pellets.
4. The method according to item 1 or 2, wherein the compounded material (2) is compounded pellets or particles obtained from compounded pellets.
5. The method according to any one of items 1-4, wherein a pressing temperature when applying heat and pressure is higher than the activation temperature of the blowing agent such that the at least one foamed layer (11′, 12′) is foamed during pressing.
6. The method according to item 5, wherein the pressing temperature is exceeding 200° C.
7. The method according to any one of the preceding items, wherein the activation temperature of the blowing agent is or exceeds 200° C.
8. The method according to any one of the preceding items, wherein the compounded material (2), such as the compounded pellets, is formed at processing temperatures being less than 200° C.
9. The method according to any one of the preceding items, wherein the compounded material (2), such as the compounded pellets, is formed at processing temperatures between 120-200° C.
10. The method according to any one of the preceding items, wherein the blowing agent is chosen from the group of azo compounds, hydrazine derivates, semicarbazides, tetrazoles, nitroso compounds, carbonates, and expandable microspheres.
11. The method according to any one of the preceding items, wherein the blowing agent comprises azodicarbonamide (ADC).
12. The method according to any one of the preceding items, wherein the thermoplastic material is chosen from the group of PVC, PP, PE, PET, TPU, PVAc, and PVB.
13. The method according to any one of items 3-12, wherein the compounded pellets (2) have a diameter and/or a thickness of 0.5 to 5 mm.
14. The method according to any one of the preceding items, wherein a first layer (11) of the compounded material (2) is applied on the carrier (10), and a second layer (12) of compounded material (2) is applied on the first layer (11).
15. The method according to any one of the preceding items, further comprising including at least one reinforcement layer (13) in or on the substrate (1; 1′; 1″).
16. The method according to item 15, further comprising applying the reinforcement layer (13) on a first layer (11) of the compounded material (2) applied on the carrier (10), and applying a second layer (11) of the compounded material (2) on the reinforcement layer (13).
17. The method according to any one of the preceding items, wherein the pressing device (30) is a double belt press.
18. The method according to any one of the preceding items, wherein the pressing device (30) comprises at least one heating zone and at least one pressing zone.
19. The method according to any one of the preceding items, wherein the compounded material (2) is formed by:
mixing the thermoplastic material with the blowing agent to a dry-blend,
compounding the dry-blend to obtain a thermoplastic compounded material comprising the blowing agent.
20. The method according to any one of items 1-18, wherein the compounded material (2) is formed by mixing and compounding the thermoplastic material with the blowing agent in an extruder.
21. The method according to item 19 or 20, further comprising pelletizing the compounded material into compounded pellets (2).
22. The method according to any one of the preceding items, wherein the compounded material (2) further comprises fillers.
23. The method according to any one of the preceding items, wherein the at least one foamed layer (11′, 12′) has a density of 1.0-1.9 kg/dm³ as measured according to ISO 1183.
24. The method according to any one of the preceding items, wherein the at least one foamed layer (11′, 12′) has a bending modulus in the range of 2000-7000 N/mm² as measured according to ISO 178.
25. The method according to any one of the preceding items, wherein the at least one foamed layer (11′, 12′) has a bending strength of at least 10 N/mm² as measured according to ISO 178.
26. The method according to any one of the preceding items, wherein the at least one foamed layer (11′, 12′) has a hardness 50-90 Shore D as measured according to ISO 868.
27. The method according to item 14 or 16, wherein the compounded material of the second layer (12) is different from the compounded material of the first layer (11).
28. The method according to item 14 or 16, wherein the compounded material of the second layer (12) is substantially similar to the compounded material of the first layer (11).
29. The method according to any one of the preceding items, wherein the method further comprises forming the compounded material (2), wherein the processing temperatures are less than 200° C., wherein the compounded material (2) is formed at the processing temperatures.
30. The method according to any one of the preceding items, wherein the compounded material (2) is formed in a compounding process, wherein the processing temperatures of the compounding process are less than 200° C.
31. A method to produce a substrate (1; 1′; 1″) comprising at least one foamed layer (11′, 12′), the method comprising
applying a compounded material (2) on a carrier (10), wherein the compounded material (2) comprises a thermoplastic material and a blowing agent,
applying heat and pressure in a pressing device (30) to the compounded material (2) to form the at least one foamed layer (11′, 12′),
wherein the blowing agent has a decomposition temperature being higher than processing temperatures for forming the compounded material (2).
32. A method to produce a substrate comprising at least one foamed layer, the method comprising:
compounding a thermoplastic material and a blowing agent to a compounded material,
applying the compounded material comprising the thermoplastic material and the blowing agent on a carrier,
applying heat and pressure in a pressing device to the compounded material to form the at least one foamed layer,
wherein the blowing agent has a decomposition temperature, being higher than processing temperatures for compounding the thermoplastic material and the blowing agent to the compounded material.
33. The method according to item 31 or 32, wherein a pressing temperature when applying heat and pressure is higher than the decomposition temperature of the blowing agent such that the at least one foamed layer (11′, 12′) is foamed during and/or after pressing.
34. A building panel comprising a substrate produced according to any one of the preceding items, wherein the substrate comprises the at least one foamed layer.
35. The building panel according to item 34, wherein the substrate is multi-layered.
36. The building panel according to item 34 or 35, wherein the substrate comprises one or more foamed layer.
37. The building panel according to any one of items 34-36, wherein the substrate comprises at least one foamed layer and at least one unfoamed layer.

1. A method to produce a substrate (1; 1′; 1″) comprising at least one foamed layer (11′, 12′), the method comprising
applying a compounded material (2) on a carrier (10), wherein the compounded material (2) comprises a thermoplastic material and a blowing agent,
applying heat and pressure in a pressing device (30) to the compounded material (2) to form the at least one foamed layer (11′, 12′),
wherein the blowing agent has an activation temperature being higher than processing temperatures for forming the compounded material (2).

2. The method according to claim 1, wherein the compounded material (2) is compounded pellets or particles obtained from compounded pellets.

3. The method according to claim 1 or 2, wherein a pressing temperature when applying heat and pressure is higher than the activation temperature of the blowing agent such that the at least one foamed layer (11′, 12′) is foamed during and/or after pressing.

4. The method according to claim 3, wherein the pressing temperature is exceeding 200° C.

5. The method according to any one of the preceding claims, wherein the activation temperature of the blowing agent is or exceeds 200° C.

6. The method according to any one of the preceding claims, wherein the method further comprises forming the compounded material (2), wherein the processing temperatures are less than 200° C., wherein the compounded material (2) is formed at the processing temperatures.

7. The method according to any one of the preceding claims, wherein the blowing agent is chosen from the group of azo compounds, hydrazine derivates, semicarbazides, tetrazoles, nitroso compounds, carbonates, and expandable microspheres.

8. The method according to any one of the preceding claims, wherein the blowing agent comprises azodicarbonamide (ADC).

9. The method according to any one of the preceding claims, wherein the thermoplastic material is chosen from the group of PVC, PP, PE, PET, TPU, PVAc, and PVB.

10. The method according to any one of claims 2-9, wherein the compounded pellets have a diameter and/or a thickness of 0.5 to 5 mm.

11. The method according to any one of the preceding claims, wherein a first layer (11) of the compounded material (2) is applied on the carrier (10), and a second layer (12) of the compounded material (2) is applied on the first layer (11).

12. The method according to any one of the preceding claims, further comprising including at least one reinforcement layer (13) in or on the substrate (1; 1′; 1″).

13. The method according to claim 12, further comprising applying the reinforcement layer (13) on a first layer (11) of the compounded material (2) applied on the carrier (10), and applying a second layer (11) of the compounded material (2) on the reinforcement layer (13).

14. The method according to any one of the preceding claims, wherein the pressing device (30) is a double belt press.

15. The method according to any one of the preceding claims, wherein the pressing device (30) comprises at least one heating zone and at least one pressing zone.

16. The method according to any one of the preceding claims, wherein the compounded material (2) is formed by mixing the thermoplastic material with the blowing agent to a dry-blend and compounding the dry-blend to obtain the compounded material comprising the blowing agent.

17. The method according to any one of claims 1-15, wherein the compounded material (2) is formed by mixing and compounding the thermoplastic material with the blowing agent in an extruder.

18. The method according to claim 16 or 17, further comprising pelletizing the compounded material into compounded pellets.

19. The method according to any one of the preceding claims, wherein the compounded material (2) further comprises fillers.

20. The method according to any one of the preceding claims, wherein the at least one foamed layer (11′, 12′) has a density of 1.0-1.9 kg/dm³ as measured according to ISO 1183.
